(19) United States
(12) Patent Application Publication
(10) Pub. No.: US 2009/0079445 A1
(43) Pub. Date: Mar. 26, 2009

(54) ISOLATED FUEL SENSOR

(76) Inventors: Yingjie Lin, El Paso, TX (US); Cecilia Hernandez, Chihuahua (MX); Daniel J. Moreno, El Paso, TX (US)

Correspondence Address: DELPHI TECHNOLOGIES, INC., M/C 480-410-202, PO BOX 5052, TROY, MI, 48007, US

(21) Appl. No.: 11/860,901

(22) Filed: Sep. 25, 2007

(51) Int. Cl. G01N 27/07

(52) U.S. Cl. 324/693

(57) ABSTRACT

A fuel sensor includes a cylindrical, one-piece plastic body that has an inlet, an outlet and a fuel passage in between. The body further includes three sensing, thin-walled plate holders that extend from the cylindrical body into and across the fuel passage. Three parallel sensing plates are disposed in the holders for use in forming a pair of parallel plate devices. The thin-walled plate holders surrounding the plates provide isolation of the plates from contact with the fuel. The body also includes a cavity to house a printed circuit board (PCB), which includes signal processing circuitry. The PCB is also isolated from exposure to the fuel. The sensing plates have leads that extend into the cavity for connection to the PCB. An interface connector for connection to an engine controller is also provided. The sensor achieves isolation from exposure to fuel without the use of any coatings.

### TECHNICAL FIELD

The present invention relates generally to sensors and more particularly to a fuel sensor having sensing elements and electronics that are isolated from the fuel.

### BACKGROUND OF THE INVENTION

Properties of gasoline, such as its conductivity or dielectric constant, are often important for operation of a motor vehicle. For example, flexible fuel vehicles are known that are designed to run on gasoline as a fuel or a blend of up to 85% ethanol (E85). Such properties can be used to determine the concentration of ethanol in a gasoline and can also determine the amount of water mixed in with the fuel. For example, experimental data shows that the fuel dielectric constant is directly proportional to the ethanol concentration but relatively insensitive to water contamination, while fuel conductivity is very sensitive to water concentration. Thus, for these applications and others, there is a need for a fuel sensor that precisely measures the impedance of fuel. More generally, therefore, engine controllers benefit from sensors that provide information regarding the composition, quality, temperature and other properties of the fuel that is delivered to the combustion chamber.

Most sensor technologies for fuel property sensing require in-situ signal processing electronics to convert the relatively small sensing signals to a suitably strong electrical signal that can be used by an external circuit, such as an engine controller, to define the measured fuel property of interest. For example only, a capacitive sensor that is configured to apply an excitation signal to spaced apart sensing plates induces a relatively small induced signal, thus requiring local electronics to preserve the signal-to-noise ratio.

Furthermore, it is known that most in-situ sensors use capacitive, inductive or magnetic technologies, which do not require direct contact or exposure to the fuel in order to assess the relevant fuel properties. In fact, these sensors generally require physical isolation from the fuel, since contact with the fuel can often degrade the performance of the sensor. While it is known to use coatings to isolate various sensor components from contact with the fuel, such coatings may induce stress and/or degrade the signal-to-noise ratio of the sensing approach.

There is therefore a need for a fuel sensor that minimizes or eliminates one or more of the problems set forth above.

### SUMMARY OF THE INVENTION

The invention achieves isolation of the sensing elements and signal processing electronics from any contact with a fuel, without the use of any coatings, encapsulants or other potting materials that would be resistant to fuel and benign to the various sensor components. This eliminates a source of performance degradation over the service life of such a fuel sensor.

An apparatus for use in sensing characteristics of fuel includes a unitary (i.e., one-piece) body having a fuel inlet, a fuel outlet and a fuel passage between the inlet and outlet. The unitary body further includes at least first and second, spaced-apart holders extending into the fuel passage. First and second sensing elements are disposed in the first and second holders. The holders, being integral with the main body, isolate the sensing elements from contact with any fuel in or flowing through the fuel passage.

In a preferred embodiment, a fuel sensor includes a unitary, cylindrical body extending along a main axis, with a fuel inlet, a fuel outlet and a fuel passage in between. The body further includes at least a pair of spaced-apart first and second sensing element holders extending into the fuel passage, and which contain first and second sensing elements.

The unitary body also contains a cavity that is adapted to house an electrical circuit. The electrical circuit is configured to produce the output signal. Each sensing element has a respective lead extending into the cavity for connection to the electrical circuit. The cavity is isolated from the fuel passage, isolating the electrical circuit from exposure to fuel. The sensor further includes a cover configured to close the cavity and seal it against outside environmental influences (e.g., water).

The unitary body also contains an interface connector having at least power, ground and output signal terminals. Finally, the sensor includes a ground shield that is disposed radially-outwardly of the cylindrical body, located around the sensing elements. The shield reduces electromagnetic emissions and also reduces the effect of any external electromagnetic interference.

Other features, aspects and advantages are presented.

### BRIEF DESCRIPTION OF THE DRAWINGS

The present invention will now be described by way of example, with reference to the accompanying drawings:

FIG. 1 is a top, perspective view of an embodiment of an isolated fuel sensor according to the invention.

FIG. 2 is a partial, cross-sectional view taken substantially along lines 2-2 in FIG. 1 showing the fuel passage and the isolated sensing elements.

FIG. 3 is a partial, cross-sectional view taken substantially along lines 3-3 in FIG. 1 showing how the sensing elements connect to a printed circuit board (PCB).

### DETAILED DESCRIPTION OF THE PREFERRED EMBODIMENT

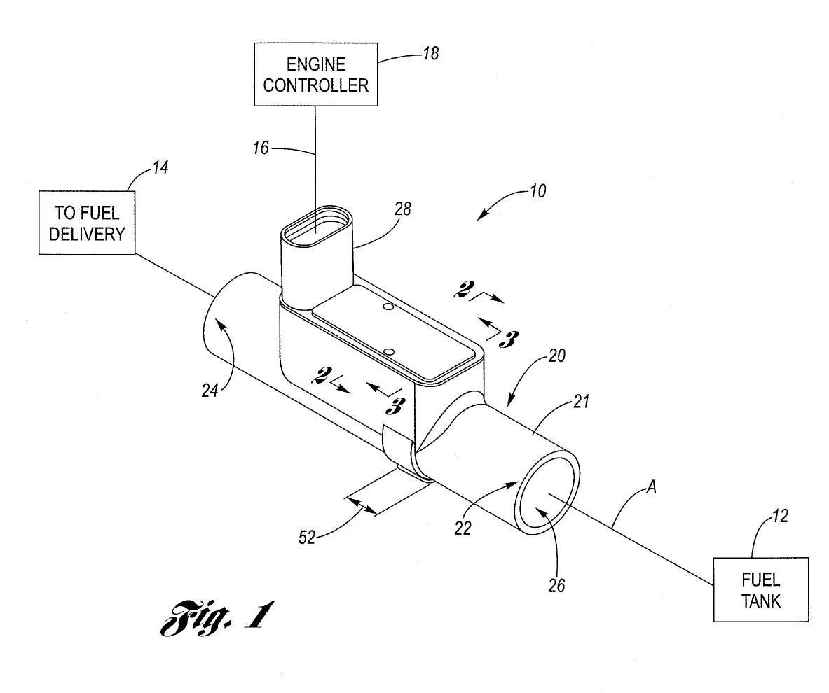

Referring now to the drawings wherein like reference numerals are used to identify identical components in the various views, FIG. 1 is a perspective view of an apparatus 10 for sensing one or more properties of a fuel. Sensing apparatus 10 is an in-line type fuel sensor that is coupled between a source of fuel, such as fuel tank 12, and a destination, such as various fuel delivery apparatus 14 associated with an automotive vehicle internal combustion engine (not shown). Sensing apparatus 10, generally, includes both sensing elements and an electrical circuit board with signal processing circuitry so as to generate an output signal 16. The output signal 16 is indicative of one or more sensed physical properties of the fuel, such as conductivity or dielectric constant. Output signal 16 may then be provided to an electronic engine controller 18 for use as known in the art, and as described in the Background, to facilitate fuel delivery control.

Apparatus 10 includes a body 20, which in the illustrated embodiment includes a generally cylindrical tube portion 21 that extends along a main, longitudinal axis labeled “A” in FIG. 1. Body 20 is preferably unitary (i.e., one piece) in construction, solid and continuous, and comprises plastic or other material that is resistant to degradation in the presence of various fuels. In one embodiment, body 20 is formed using an engineering plastic, such as a thermoplastic material known as acetal (or sometimes polyacetal). Since body 20 is unitary, the internal walls, structural features and the like (as described and illustrated in greater detail below) are formed of the same material. Since there are no interfaces of dissimilar materials, the sensing elements and electronics of the apparatus do not have to be sealed for protection to fuel exposure and fuel line pressure. The preferred embodiment comprises a seamless, uniform surface that is formed during a single injection molding process. A two-step molding process with the same material, alternatively, will require fusion or melting of the pre-mold to the second over-mold to ensure a consistent surface in the internal fuel flow region of sensing body.

Unitary body 20 includes an inlet 22, an outlet 24 and a fuel passage 26 formed in between. Inlet 22 and outlet 24 each include a respective interface that is suitable for connection to a fuel hose or tube or other mechanism, as per the requirements of any particular application.

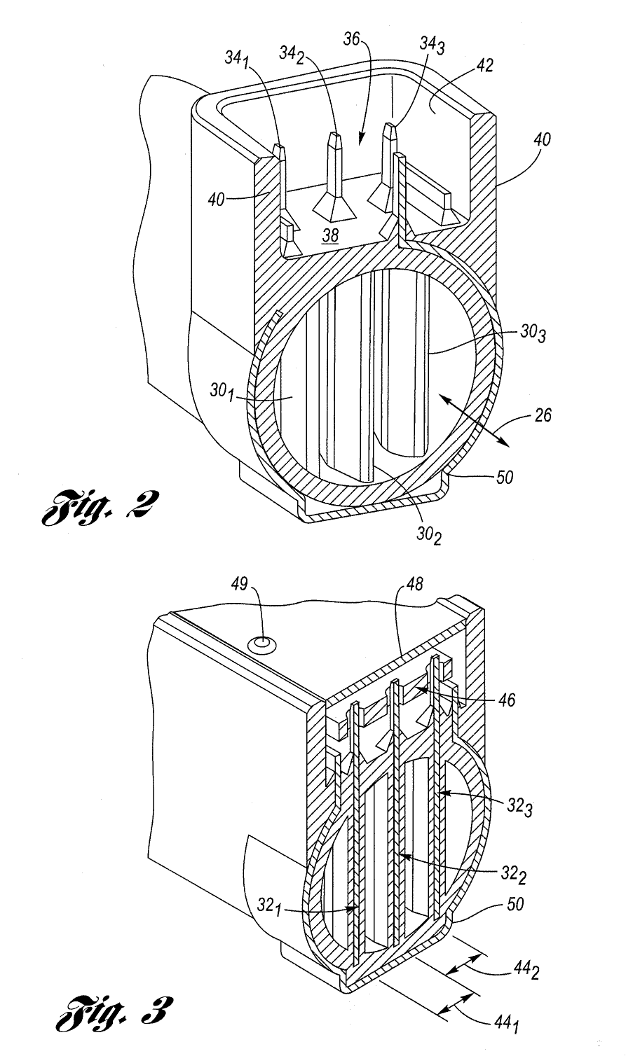

Body 20 also includes an interface connector 28, which may include a plurality of electrical terminals (best shown in FIGS. 2-3). In one embodiment, body 20 may include power, ground and output signal electrical terminals.

FIGS. 2 and 3 are cross-sectional views taken substantially along lines 2-2 and 3-3 in FIG. 1, respectively. Unitary body 20 also includes a plurality of spaced-apart, thin-walled sensing element holders 30₁, 30₂ and 30₃. In the illustrated embodiment there are three such holders shown. Holders 30₁, 30₂ and 30₃ are configured to receive and retain a corresponding plurality of sensing elements, which in the illustrated embodiment comprise sensing plates 32₁, 32₂ and 32₃. Holders 30₁, 30₂ and 30₃ are integrally formed with the remainder of body 20 and preferably extend into fuel passage 26 so as to allow effective sensing of the one or more of the physical properties of a fuel in or flowing through passage 26. In the illustrated embodiment, not only do the holders extend into fuel passage 26, but extend completely across passage 26 so as to allow the corresponding sensing plates 32₁, 32₂ and 32₃ to bound as large a volume of fuel as possible.

It should be appreciated that while the illustrated embodiment shows three sensing plates 32₁, 32₂ and 32₃, two plates may be sufficient for certain application and an even greater number of plates may be provided in other applications. The operating principle being that two sensing plates that have fuel between them may be used to ascertain one or more physical properties or characteristics. The sensing plates 32₁, 32₂ and 32₃ are preferably substantially parallel to each other, and the holders 30₁, 30₂ and 30₃ are configured to achieve this orientation. Moreover, the sensing plates 32₁, 32₂ and 32₃ are substantially perpendicular to longitudinal axis “A” (best shown in FIG. 1), and may be (but need not be) spaced apart by substantially equal distances, as best shown in FIG. 3 (i.e., separation distances 44₁ and 44₂ are substantially equal in the illustrated embodiment). Sensing plates 32₁, 32₂ and 32₃ may comprise electrically-conductive material such as various metals and alloys known in the art for constructing sensing plates.

Typical embodiments of the present invention use a copper-based terminal, such as brass, that is tin-plated at the PCB interface for optimization of the solder interface.

FIG. 2 further shows that each sensing plate 32₁, 32₂ and 32₃ includes a respective connection lead 34₁, 34₂ and 34₃. These leads 34₁, 34₂ and 34₃ extend into a cavity 36. Cavity 36 is also an integral part of the body 20 and is defined by a floor 38 and one or more sidewalls 40 extending away from the floor 38. Note that the floor 38 separates and isolates the cavity from the fuel passage 26. The cavity 36 also has an opening 42 that is opposite the floor 38.

FIG. 3 shows that cavity 36 is configured in size and shape to house an electrical circuit, such a printed circuit board (PCB) 46 that is arranged to include various signal processing circuitry. The signal processing circuitry is configured to apply suitable excitation signals to the sensing plates 32₁, 32₂ and 32₃ and to detect and process the resulting induced signals to develop the output signal 16 described above that indicates a physical property of the fuel. The leads 34₁, 34₂ and 34₃ are configured is size, extension length and material so as to be suited for direct connection to PCB 46 (e.g., by soldering). In the illustrated embodiment, the sensing plates 32₁, 32₂ and 32₃ and corresponding leads 34₁, 34₂ and 34₃ are directly over-molded as part of the process of forming unitary body 20. Alternatively, the holders 30₁, 30₂ and 30₃ may be formed with each having a respective slot that opens toward the cavity 36, for example, so as to allow for the subsequent insertion of the sensing plates. It should be appreciated that in either case, over-molding or post-molding insertion into slots, the holders are integrally formed with the rest of body 20 so as to avoid undesirable material interfaces, as described in the Background. In both cases, however, the sensing plates are isolated from any contact with the fuel. Also, since the floor 38 separates and isolates the cavity 36 from the fuel passage 26, the electronics are protected and isolated from contact with the fuel.

FIG. 3 also shows a cover 48 configured to match opening 42 to close the cavity 36, sealing and protecting PCB 46 and sensing plates 32₁, 32₂ and 32₃ from various environmental influences that would otherwise enter through opening 42, for example, water. It warrants emphasizing that cover 48 need not be configured to be resistant to fuel degradation since the fuel is isolated within fuel passage 26, while the sensing apparatus 10, generally speaking, as a whole is deployed in the air. Cover 48 may be retained using conventional retention approaches, for example through use of conventional fasteners 49.

FIGS. 2 and 3 also show a ground shield 50. Shield 50 performs two main functions. First, shield 50 is configured to minimize or eliminate the effect that stray or external electromagnetic interference may otherwise have on the sensing plates 32₁, 32₂ and 32₃. Second, shield 50 is also configured to minimize or eliminate any electromagnetic emissions produced by the excitation of the sensing plates 32₁, 32₂ and 32₃ from propagating outwards from sensing apparatus 10. As to construction, shield 50 comprises electrically-conductive material such as various metals and is coupled to the ground terminal of interface connector 28, either directly via internal conductors or indirectly via connections on PCB 46. In the illustrated embodiment, the shield 50 is generally disposed radially outwardly of the tube portion 21 of body 20, and is configured to substantially circumscribe, at least in the radial direction, the plurality of sensing plates 32₁, 32₂ and 32₃. In this regard, shield 50 has a width that extends axially by a distance 52 (best shown in FIG. 1), which substantially corresponds to the axial extension of the sensing plates 32₁, 32₂ and 32₃.

It should be understood that in the present disclosure, a pair of sensing plates, with fuel present in between, will appear to the electronics on PCB 46 as a complex load (e.g., a parallel combination of a resistor and a capacitor). This complex impedance comprises a real component part (resistive) and an imaginary component part (capacitive), which can be correlated to conductivity and a dielectric constant, useful physical properties of the fuel. The art is replete with approaches for measuring the complex impedance, or components thereof, for purposes of ascertaining one or more physical properties of the fuel, for example, as seen by reference to U.S. application Ser. No. 10/199,651 filed Jul. 19, 2002, now U.S. Pat. No. 6,693,444 B2 entitled “CIRCUIT DESIGN FOR LIQUID PROPERTY SENSOR” issued Feb. 17, 2004 to Lin et al., owned by the common assignee of the present invention, and hereby incorporated by reference in its entirety herein, or as seen by reference to U.S. provisional application Ser. No. 60/890,112 filed 15 Feb. 2007, now pending, entitled “LIQUID PROPERTIES SENSOR CIRCUIT” to Lin et al., owned by the common assignee of the present invention and hereby incorporated by reference in its entirety herein.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An apparatus for use in sensing characteristics of fuel, comprising:
a unitary body having a fuel inlet, a fuel outlet and a fuel passage between said inlet and outlet, said body further including spaced-apart first and second holders extending into said passage; and
first and second sensing elements disposed in said first and second holders so as to be isolated from passage.

2. The apparatus of claim 1 wherein said body comprises electrically-insulating thermoplastic material.

3. The apparatus of claim 2 wherein said thermoplastic material comprises acetal material.

4. The apparatus of claim 1 wherein said body further includes a cavity having a floor and an opening opposite said floor, said cavity being configured to house an electrical circuit, said apparatus further including a cover configured to close said cavity, said floor isolating said cavity from said passage.

5. The apparatus of claim 4 wherein said sensing elements comprise electrically-conductive material, said sensing elements each having a lead extending into said cavity for connection to said electrical circuit.

6. The apparatus of claim 5 wherein said electrical circuit is configured on a printed circuit board (PCB).

7. The apparatus of claim 4 wherein said sensing element holders each comprise a respective thin wall structure with a central slot opening towards said cavity configured to allow insertion of said sensing element.

8. The apparatus of claim 4 wherein said leads extend through said floor into said cavity.

9. The apparatus of claim 8 wherein said sensing elements are over-molded with said body.

10. The apparatus of claim 1 wherein said body further including a connector comprising electrical terminals.

11. The apparatus of claim 1 further including a ground shield comprising electrically-conductive material, said ground shield being located outwardly of said body proximate said sensing elements.

12. The apparatus of claim 1 further including a third sensing element in a third holder.

13. The apparatus of claim 1 wherein said first and second sensing elements are configured for determining complex impedance of a fuel flowing through said passage indicative of one or more of said characteristics of said fuel.

14. An fuel sensor comprising:
a unitary body having a fuel inlet, a fuel outlet and a fuel passage between said inlet and outlet, said body further including spaced-apart first and second holders extending into said passage;
a cavity in said body having a floor and an opening opposite said floor, said cavity housing an electrical circuit, said sensor further including a cover configured to close said cavity, said floor isolating said cavity from said fuel passage;
an interface connector in said body comprising power, ground and output signal terminals;
first and second electrically-conductive sensing elements disposed in said first and second holders each having a respective lead extending into said cavity for connection to said electrical circuit; and
a ground shield outwardly of said body proximate said sensing elements, said ground shield coupled to said ground terminal.

15. The apparatus of claim 14 wherein said electrical circuit is configured to excite said sensing elements and produce resulting induced signals to produce an output signal indicative of one or more properties of a fuel flowing through said fuel passage.

16. The apparatus of claim 15 wherein said thermoplastic material comprises acetal material.

17. An fuel sensor for producing an output signal indicative of a property of a fuel, comprising:
a unitary, cylindrical body extending along a main axis, said body having a fuel inlet, a fuel outlet and a fuel passage between said inlet and outlet, said body further including spaced-apart first, second and third holders extending into said passage;
a cavity in said body defined by a floor and sidewalls extending from said floor, said cavity having an opening opposite said floor, said cavity housing an electrical circuit, said sensor further including a cover configured to close said cavity, said floor isolating said cavity from said fuel passage;
an interface connector in said body comprising power, ground and output signal terminals;
first, second and third electrically-conductive sensing elements disposed in said holders each having a respective lead extending into said cavity for connection to said electrical circuit; and
a ground shield radially-outwardly of said cylindrical body proximate said sensing elements, said ground shield coupled to said ground terminal.

18. The sensor of claim 17 wherein said sensing elements comprises parallel plates.

19. The sensor of claim 18 wherein said sensing elements are equally spaced apart.

20. The sensor of claim 17 wherein said ground shield has an axial extent that substantially corresponds to an axial extent of the sensing elements.
